(19) United States
(12) Patent Application Publication
(10) Pub. No.: US 2011/0145914 A1
(43) Pub. Date: Jun. 16, 2011

(54) MOTHERBOARD AND METHOD FOR MANAGING USE OF COMPUTER

(75) Inventor: Hong-Ru ZHU, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/815,411

(22) Filed: Jun. 15, 2010

(30) Foreign Application Priority Data
Dec. 15, 2009 (CN) 200910311476.6

(51) Int. Cl. H04L 9/32; G06F 15/177

(52) U.S. Cl. 726/19; 713/2

(57) ABSTRACT

A system and method for managing use of a computer determines if a first system time of the computer is in one of the preset available time segments when the computer is powered on, and logs into the operating system of the computer if the first system time is in one of the available time segments. The system and method further determines if a second system time is in one of preset unavailable time segments if a time interval elapses after logging into the operating system, and shuts down the power of the computer if the second system time is in one of the unavailable time segments.

### BACKGROUND

1. Technical Field

Embodiments of the present disclosure relate to motherboard design technology, and particularly to a motherboard and method for managing the use of a computer.

2. Description of Related Art

Currently, computer games are popular with many people, especially children. To restrict time usage of the computer, an auxiliary power supply including a timer can be used. However, this kind of auxiliary power supply can be expensive and has certain faults, including the children having the ability to easily cut off the power of the auxiliary power supply, subsequently bypassing the security controls intended by the power supply.

What is needed, therefore, is an improved system and method for managing the use of a computer.

### BRIEF DESCRIPTION OF THE DRAWINGS

FIG. 1 is a block diagram of one embodiment of a motherboard comprising a basic input output system.

FIG. 2 is a flowchart of one embodiment of a method for managing the use of a computer using a motherboard shown in FIG. 1.

FIG. 3 is a detailed flowchart of one embodiment of block S1 in FIG. 2.

### DETAILED DESCRIPTION

All of the processes described below may be embodied in, and fully automated through, functional code modules executed by one or more general purpose computers or processors. The code modules may be stored in any type of readable medium or other storage device. Some or all of the methods may alternatively be embodied in specialized hardware. Depending on the embodiment, the readable medium may be a hard disk drive, a compact disc, a digital video disc, or a tape drive.

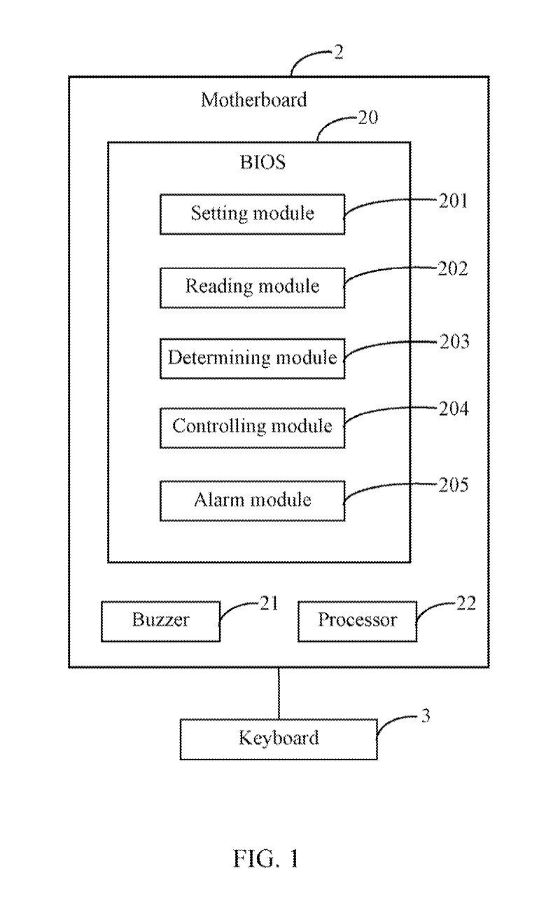

FIG. 1 is a block diagram of one embodiment of a motherboard 2 comprising a basic input output system (BIOS) 20. In one embodiment, the motherboard 2 may be located in a computer, and the BIOS 20 may be used to control a usage time of the computer. A keyboard 3 may be connected with the motherboard 2, and the keyboard 3 is provided for manually inputting data into the BIOS 20. A detailed description will be given in the following paragraphs.

In one embodiment, the motherboard 2 includes a buzzer 21 and a processor 22. The BIOS 20 stores user-defined data, such as available time segments and unavailable time segments. If a current system time of the computer is in one of the available time segments, the computer is available. If the current system time of the computer is in one of the unavailable time segments, the computer is unavailable. For example, an available time segment may be from 6:00 am to 7:00 pm, and an unavailable time segment may be from 7:00 pm to 6:00 am.

In one embodiment, the BIOS 20 further includes a setting module 201, a reading module 202, a determining module 203, a controlling module 204, and an alarm module 205. In one embodiment, the modules 201-205 comprise one or more computerized instructions that are stored in the BIOS 20. The processor 22 of the motherboard 2 executes the computerized instructions to implement one or more operations of the computer.

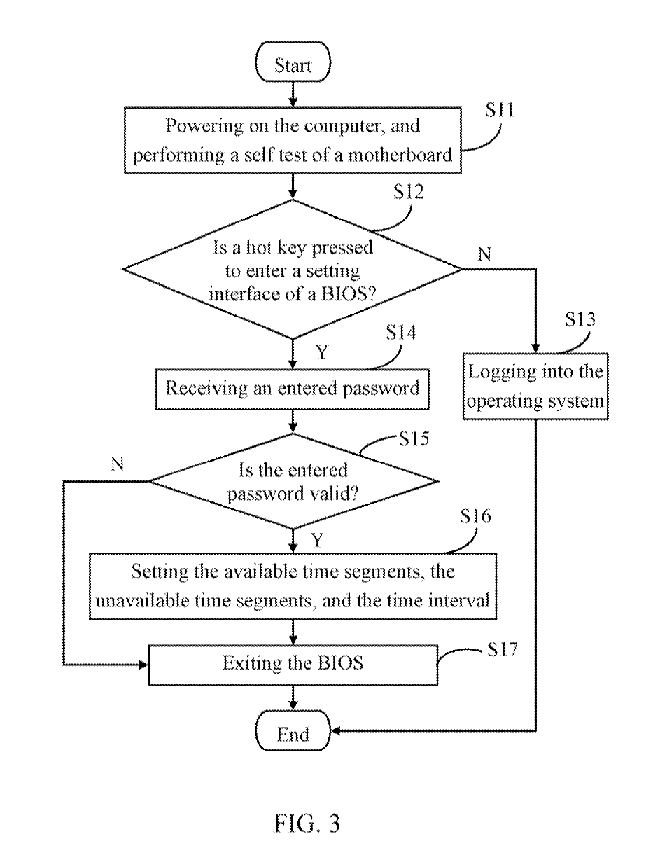

The setting module 201 sets the available time segments, the unavailable time segments, and a time interval to use the computer manually, and store the available time segments, the unavailable time segments, and the time interval in the BIOS 20. For example, the available time segments are [12:00-13:00] and [17:30-18:30], the unavailable time segments are [18:30-24:00], [00:00-12:00], and [13:00-17:30], and the time interval is five minutes. In other embodiments, the available time segments, the unavailable time segments, and the time interval may be changed manually when the computer is available. Detailed descriptions will be provided in FIG. 3.

The reading module 202 reads a first system time of the computer from a clock generator of the computer when the computer is powered on.

The determining module 203 determines if the first system time is in one of the available time segments.

The controlling module 204 shuts down the power of the computer if the first system time is not in one of the available time segments.

The controlling module 204 runs a boot program of the computer, and logs into an operating system of the computer if the first system time is in one of the available time segments.

The reading module 202 further reads a second system time of the computer if the time interval elapses after logging into the operating system by the boot program of the computer.

The determining module 203 further determines if the second system time is in one of the unavailable time segments.

The alarm module 205 outputs an alarm signal through the buzzer 21 of the motherboard 2 if the second system time is in one of the unavailable time segments. Then, the controlling module 204 shuts down the power of the computer.

The controlling module 204 keeps running current applications of the computer if the second system time is not in one of the unavailable time segments.

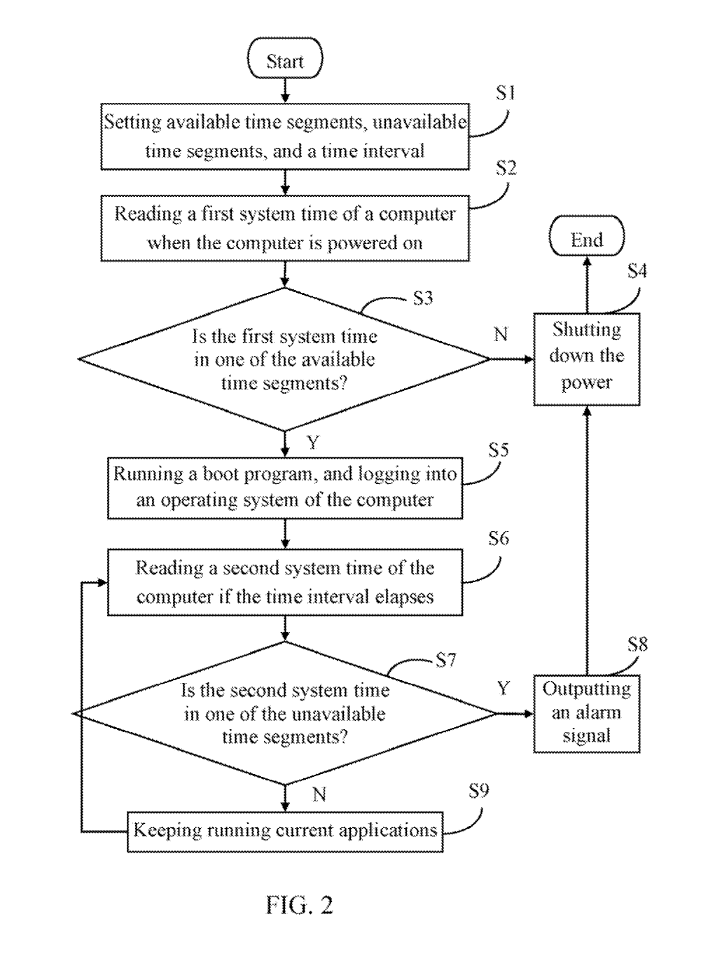

FIG. 2 is a flowchart of one embodiment of a method for managing use of a computer using the motherboard 2 shown in FIG. 1. Depending on the embodiment, additional blocks may be added, others removed, and the ordering of the blocks may be changed.

In block S1, the setting module 201 sets available time segments, unavailable time segments, and a time interval to use the computer manually, and store the available time segments, the unavailable time segments, and the time interval in the BIOS 20. Detailed descriptions will be provided in FIG. 3.

In block S2, the reading module 202 reads a first system time of the computer from a clock generator of the computer when the computer is powered on.

In block S3, the determining module 203 determines if the first system time is in one of the available time segments. If the first system time is not in one of the available time segments, the procedure goes to block S4. If the first system time is in one of the available time segments, the procedure goes to block S5.

In block S4, the controlling module 204 shuts down the power of the computer, then the procedure ends.

In block S5, the controlling module 204 runs a boot program of the computer, and logs into an operating system of the computer, then the procedure goes to block S6.

In block S6, the reading module 202 reads a second system time of the computer if the time interval elapses after logging into the operating system by the boot program of the computer.

In block S7, the determining module 203 determines if the second system time is in one of the unavailable time segments. If the second system time is in one of the unavailable time segments, the procedure goes to block S8. If the second system time is not in one of the unavailable time segments, the procedure goes to block S9.

In block S8, the alarm module 205 outputs an alarm signal through the buzzer 21 of the motherboard 2, then the procedure goes to block S4.

In block S9, the controlling module 204 keeps running current applications of the computer, then the procedure goes to block S6.

FIG. 3 is a detailed flowchart of one embodiment of block S1 in FIG. 2. Depending on the embodiment, additional blocks may be added, others removed, and the ordering of the blocks may be changed.

In block S11, the computer is powered on, and the BIOS 20 performs a self test of the motherboard 2.

In block S12, the setting module 201 determines if a hot key of the keyboard 3 is pressed to enter a setting interface of the BIOS 20. If no hot key is pressed to enter the setting interface of the BIOS 20, the procedure goes to block S13. If there is a hot key is pressed to enter the setting interface of the BIOS 20, the procedure goes to block S14. In one embodiment, the hot key may be “F1” of the keyboard 3.

In block S13, the BIOS 20 runs a boot program, and logs into the operating system of the computer.

In block S14, the setting module 201 receives an entered password from the keyboard 3, then the procedure goes to block S15.

In block S15, the setting module 201 determines if the entered password is valid. If the entered password is the same as a preset password, the setting module 202 determines that the entered password is valid, the procedure goes to block S16. If the entered password is not the same as the preset password, the setting module 202 determines that the entered password is not valid, the procedure goes to block S17.

In block S16, the setting module 201 sets the available time segments, the unavailable time segments, and the time interval to use the computer, and stores the available time segments, the unavailable time segments, and the time interval in the BIOS 20.

In block S17, the setting module 201 exits the BIOS 20, and restarts the computer.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method for managing use of a computer, comprising:
setting available time segments, unavailable time segments, and a time interval to allow use of the computer, and storing the available time segments, the unavailable time segments, and the time interval in a basic input output system (BIOS) of a motherboard of the computer;
reading a first system time of the computer when the computer is powered on, and determining if the system time is in one of the available time segments;
running a boot program of the computer, and logging into an operating system of the computer if the first system time is in one of the available time segments;
reading a second system time of the computer if the time interval elapses after logging into the operating system, and determining if the second system time is in one of the unavailable time segments; and
shutting down the power of the computer if the second system time is in one of the unavailable time segments, or keep running current applications of the computer if the second system time is not in one of the unavailable time segments.

2. The method according to claim 1, further comprising: shutting down the power of the computer if the first system time is not in one of the available time segments.

3. The method according to claim 1, wherein the step of setting available time segments, unavailable time segments, and a time interval comprises:
powering on the computer, and performing a self test of the motherboard;
determining if a hot key of a keyboard is pressed to enter a setting interface of the BIOS;
running a boot program, and logging into the operating system of the computer if no hot key is pressed to enter the setting interface of the BIOS, or receiving an entered password from the keyboard if a hot key is pressed to enter the setting interface of the BIOS;
determining if the entered password is valid; and
exiting the BIOS directly if the entered password is not valid, or setting the available time segments, the unavailable time segments, and the time interval to use the computer if the entered password is valid, storing the available time segments, the unavailable time segments, and the time interval in the BIOS, exiting the BIOS and restarting the computer.

4. The method according to claim 3, wherein the hot key is “F1.”

5. The method according to claim 3, wherein the step of determining if the entered password is valid comprises:
determining that the entered password is valid if the entered password is the same as a preset password; or
determining that the entered password is not valid if the entered password is not the same as the preset password.

6. The method according to claim 1, further comprising:
outputting an alarm signal through a buzzer of the motherboard if the second system time is in one of the unavailable time segments.

7. A storage medium having stored thereon instructions that, when executed by a processor in a motherboard of a computer, causes the processor to perform a method for managing use of the computer, the method comprising:
setting available time segments, unavailable time segments, and a time interval to allow use of the computer, and storing the available time segments, the unavailable time segments, and the time interval in a basic input output system (BIOS) of a motherboard of the computer;
reading a first system time of the computer when the computer is powered on, and determining if the system time is in one of the available time segments;
running a boot program of the computer, and logging into an operating system of the computer if the first system time is in one of the available time segments;
reading a second system time of the computer if the time interval elapses after logging into the operating system, and determining if the second system time is in one of the unavailable time segments; and
shutting down the power of the computer if the second system time is in one of the unavailable time segments; or
keeping running current applications of the computer if the second system time is not in one of the unavailable time segments.

8. The storage medium according to claim 7, further comprising: shutting down the power of the computer if the first system time is not in one of the available time segments.

9. The storage medium according to claim 7, wherein the step of setting available time segments, unavailable time segments, and a time interval comprises:
powering on the computer, and performing a self test of the motherboard;
determining if a hot key of a keyboard is pressed to enter a setting interface of the BIOS;
running a boot program, and logging into the operating system of the computer if no hot key is pressed to enter the setting interface of the BIOS, or receiving an entered password from the keyboard if a hot key is pressed to enter the setting interface of the BIOS;
determining if the entered password is valid; and
exiting the BIOS directly if the entered password is not valid, or setting the available time segments, the unavailable time segments, and the time interval to use the computer if the entered password is valid, storing the available time segments, the unavailable time segments, and the time interval in the BIOS, exiting the BIOS and restarting the computer.

10. The storage medium according to claim 9, wherein the hot key is “F1”.

11. The storage medium according to claim 9, wherein the step of determining if the entered password is valid comprises:
determining that the entered password is valid if the entered password is the same as a preset password; or
determining that the entered password is not valid if the entered password is not the same as the preset password.

12. The storage medium according to claim 7, further comprising: outputting an alarm signal through a buzzer of the motherboard if the second system time is in one of the unavailable time segments.

13. The storage medium according to claim 7, wherein the medium is selected from the group consisting of a hard disk drive, a compact disc, a digital video disc, and a tape drive.

14. A system for managing use of a computer, comprising:
a setting module operable to set available time segments, unavailable time segments, and a time interval to allow use of the computer, and store the available time segments, the unavailable time segments, and the time interval in a basic input output system (BIOS) of a motherboard of the computer;
a reading module operable to read a first system time of the computer when the computer is powered on;
a determining module operable to determine if the system time is in one of the available time segments;
the controlling module further operable to run a boot program of the computer, and log into an operating system of the computer if the first system time is in one of the available time segments;
the reading module further operable to read a second system time of the computer if the time interval elapses after logging into the operating system;
the determining module further operable to determine if the second system time is in one of the unavailable time segments;
the controlling module further operable to shut down the power of the computer if the second system time is in one of the unavailable time segments, or keep running current applications of the computer if the second system time is not in one of the unavailable time segments.

15. The system according to claim 14, wherein the controlling module further operable to shut down the power of the computer if the first system time is not in one of the available time segments.

16. The system according to claim 14, wherein the setting module sets available time segments, unavailable time segments, and a time interval by:
powering on the computer, and performing a self test of the motherboard;
determining if a hot key of a keyboard is pressed to enter a setting interface of the BIOS;
running a boot program, and logging into the operating system of the computer if no hot key is pressed to enter the setting interface of the BIOS, or receiving an entered password from the keyboard if a hot key is pressed to enter the setting interface of the BIOS;
determining if the entered password is valid; and
exiting the BIOS directly if the entered password is not valid, or setting the available time segments, the unavailable time segments, and the time interval to use the computer if the entered password is valid, storing the available time segments, the unavailable time segments, and the time interval in the BIOS, exiting the BIOS and restarting the computer.

17. The system according to claim 16, wherein the hot key is “F1”.

18. The system according to claim 16, wherein the setting module determines if the entered password is valid by:
determining that the entered password is valid if the entered password is the same as a preset password; or
determining that the entered password is not valid if the entered password is not the same as the preset password.

19. The system according to claim 14, further comprising: an alarm module operable to output an alarm signal through a buzzer of the motherboard if the second system time is in one of the unavailable time segments.
